(19) United States
(12) Patent Application Publication
(10) Pub. No.: US 2010/0169768 A1
(43) Pub. Date: Jul. 1, 2010

(54) Spell Checker That Teaches Rules of Spelling

(75) Inventors: Stephen F. Correl, Portland, OR (US); Pradeep Satyanarayana, Beaverton, OR (US); Debora Velarde, Beaverton, OR (US); Brent W. Yardley, Hillsboro, OR (US)

Correspondence Address: Lieberman & Brandsdorfer, LLC, 802 Still Creek Lane, Gaithersburg, MD, 20878, US

(73) Assignee: International Business Machines Corporation, Armonk, NY (US)

(21) Appl. No.: 12/346,943

(22) Filed: Dec. 31, 2008

(51) Int. Cl. G06F 17/21

(52) U.S. Cl. 715/257

(57) ABSTRACT

A method, system, and article are provided for determining the source of a spelling error and teaching the rule associated with the error. The computer system is configured with a review module in communication with managers to support identification of a spelling error and associating a rule with the error. The rule is communicated to mitigate repeating the spelling error in a future spelling review.

### BACKGROUND

1. Technical Field

This invention relates to an educational tool employed to teach correct aspects of spelling. More specifically, the invention relates to document review tool that identifies the basis for a determined incorrectly spelled words, and leverages an exercise to mitigate future spelling errors based upon the identified basis.

2. Background of the Invention

It is recognized in the art of personal computing, that documents are created by users for various tasks. The documents may be created by professionals in relation to their line of work. Similarly, the documents may be created by students to complete tasks and assignments for courses they are attending. Regardless of the scenario, a significant quantity of these documents is created through the use of a word processor or similar programs. A word processor supports creation, modification, display, and storage of a document through the use of a keyboard in communication with the personal computer. The typewriter is the predecessor to the word processor. One of the advantages of the word processor over the typewriter is the ability to enter changes into the document without re-typing the document in its entirety.

If a typing mistake is made, a cursor on the display may be properly positioned to allow for correction of the mistake. Similarly, text may be inserted or deleted from anywhere in the document. Word processors vary considerably, but all word processors support the following basic features: allows text to be inserted anywhere in the document, deletion of characters, words, lines, or pages, cut and paste, copy, adjustment of page size and margins, and search and replace a particular word or phrase. In addition, most word processors support additional features that enable manipulation and format of documents in more sophisticated ways. These more advanced word processors support a utility that allows words in the document to be reviewed for spelling errors, also known as a spell checker. In one embodiment, a spell checker is a program that checks the spelling of words in a text document. Spell checker utilities are particularly valuable for finding typographical errors in the document.

However, there are drawbacks associated with spell checker utilities. For example, a spell checker does not function properly when a mis-spelled word creates another valid word. Similarly, the spell checker suggest one or more replacement words to correct an improperly spelled word, but does not support teaching the basis for the improper spelling of the word. Most likely, the person who mis-spelled the word will repeat this action in the future. Accordingly, there is a need for a tool that communicates the basis for the improper spelling in a manner to mitigate future repetition of the ascertained spelling error.

### BRIEF SUMMARY

This invention comprises a method, system, and article for teaching the source of a spelling error within a module established to review spelling errors.

In one aspect of the invention, a method is provided for teaching the reasoning of a spelling error. A document is reviewed in search of at least one improperly spelled word. The review may include all of the words in the document. During the review process, all words found in the document are examined to determine if there is a spelling error in the document. The review process includes reviewing a database of spelling rules pertaining to the spelling error. It is then determined if at least one of the spelling rules applies to the words subject to the spelling error. If a matching spelling rule is ascertained, the spelling rule that explains an underlying source of the spelling error is displayed.

In another aspect of the invention, a computer system is provided with a processor in communication with memory. A review module is provided in communication with the process. The review modules supports review of a document in search of at least one improperly spelled word. In one embodiment, the review module searches the entire document. The review module examines all words found in the document determined to have a spelling error, and consults a database of spelling rules associated with the spelling error. An error manager is provided in communication with the review module. The error manager determines if at least one of the spelling rules apply to the words subject to the spelling error. A visual display is provided in communication with the processor and the error manager to convey data. More specifically, the visual display conveys at least one spelling rule to explain an underlying source of the spelling error.

In yet another aspect of the invention, an article is provided to review a document for spelling errors. The article includes a computer readable carrier including computer program instructions configured to teach a correction of the spelling error. Instructions are provided to review a document in search of at least one improperly spelled word, including reviewing all of the words in the document. In response to the review, instructions are provided to examine all words found in the document determined to have a spelling error. This examination includes reviewing a database of spelling rules associated with the spelling error. Instructions are provided to determine if at least one of the spelling rules apply to the words subject to the spelling error. At least one spelling rules determined to be appropriate is displayed to explain an underlying source of the spelling error.

Other features and advantages of this invention will become apparent from the following detailed description of the presently preferred embodiment of the invention, taken in conjunction with the accompanying drawings.

### BRIEF DESCRIPTION OF THE SEVERAL VIEWS OF THE DRAWINGS

The drawings referenced herein form a part of the specification. Features shown in the drawing are meant as illustrative of only some embodiments of the invention, and not of all embodiments of the invention unless otherwise explicitly indicated. Implications to the contrary are otherwise not to be made.

FIG. 1 is a flow chart illustrating employment of a teaching module in conjunction with a spelling error review module according to the preferred embodiment of this invention, and is suggested for printing on the first page of the issued patent.

FIG. 2 is a flow chart illustrating the educational module extrapolated to leverage the use of the processor and memory module of the computing device.

FIG. 3 is a block diagram illustrating placement of the tools for the teaching module.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the spirit and scope of the invention, as claimed, but is merely representative of selected embodiments of the invention.

The functional units described in this specification have been labeled as modules and managers. A module(s) and manager(s) may be implemented in programmable hardware devices such as field programmable gate arrays, programmable array logic, programmable logic devices, or the like. The module(s) and manager(s) may also be implemented in software for execution by various types of processors. An identified module and/or manager of executable code may, for instance, comprise one or more physical or logical blocks of computer instructions which may, for instance, be organized as an object, procedure, function, or other construct. Nevertheless, the executables of an identified module and/or manager need not be physically located together, but may comprise disparate instructions stored in different locations which, when joined logically together, comprise the module and/or manager and achieve the stated purpose of the manager.

Indeed, a modules and/or manager of executable code could be a single instruction, or many instructions, and may even be distributed over several different code segments, among different applications, and across several memory devices. Similarly, operational data may be identified and illustrated herein within the module and/or manager, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

### Technical Details

In the following description of the embodiments, reference is made to the accompanying drawings that form a part hereof, and which shows by way of illustration the specific embodiment in which the invention may be practiced. It is to be understood that other embodiments may be utilized because structural changes may be made without departing form the scope of the present invention.

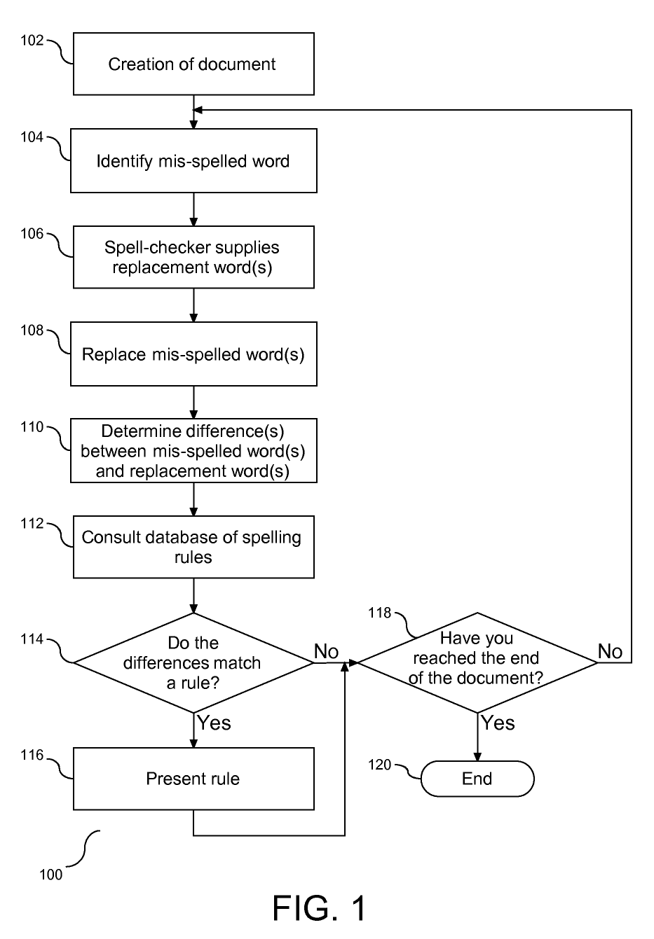

As noted above, the novelty lies in the aspect of teaching the source of the spelling error to mitigate repetition of the error(s). FIG. 1 is a flow chart (100) illustrating employment of a teaching module in conjunction with a spelling error review module, commonly known in the art as a spell checker. As is known in the art, the spell checker may be invoked to review a document for spelling errors as the document is being created, or following creation of the document (102). In response to finding a mis-spelled word (104), the spell-checker supplies one or more words available to replace the found mis-spelled word (106). At least one of the replacement words provided by the spell-checker is selected and replaces the found mis-spelled word (108). In one embodiment, if none of the replacement words are appropriate, a new word may be manually entered to replace the found mis-spelled word. Alternatively, it may be determined that the found mis-spelled word is the intended spelling and does not require replacement. Following step (108), the difference(s) between the found mis-spelled word and the replacement word are ascertained (110), and a database of spelling rules is consulted (112). The purpose of the rules is to explain the source of the error and how to correct it so that the error will not be repeated in the future. Accordingly, the teaching module corrects the error that also teaches the source of the error to mitigate a repeat of the mistake in the same or future documents.

At step (112), it is determined if the ascertained difference(s) between the mis-spelled word and the replacement word match one or more rules in the database of rules (114). If a match at step (114) is found, the rule is presented (116). There are various embodiments that may be employed for displaying a rule, including but not limited to, employment of a window on a visual display. If a match is not found at step (114) or following step (116), it is determined if the document review for spelling errors is complete (118). A negative response to the determination at step (118) is following by a return to step (104) to continue searching the document for a spelling error. Conversely, a positive response to the determination at step (118) is followed by a conclusion of the document review (120). Accordingly, the rules function through an educational module added to a spell check to enhance the functionality associated with a spell checker.

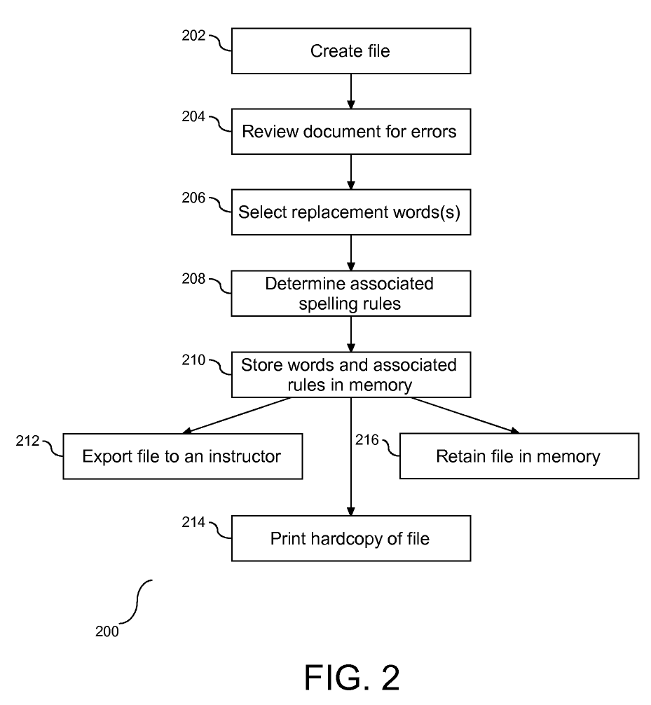

It is known in the art that spell checkers are employed in the art of personal computing and other computing devices. All such computing devices employ at least one processor and a memory module. FIG. 2 is a flow chart (200) of the educational module extrapolated to leverage the use of the processor and memory module of the computing device. More specifically, when the spell checker is invoked, a file is created (202). As the spell checker reviews the documents for errors (204), replacement words are selected (206), and rules associated with the spelling error are determined (208), each of the words and associated rules are stored in memory (210). The file may be exported to an instructor (212), printed onto a hard copy (214), and/or retained in memory (216). In one embodiment, statistics of error repetition are maintained. Accordingly, the processor and memory that facilitates execution of the spell checker may also be employed to manage the association of the spelling rules to the ascertained errors.

In one embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, or transport the program for use by or in connection with the instruction execution system, apparatus, or device.

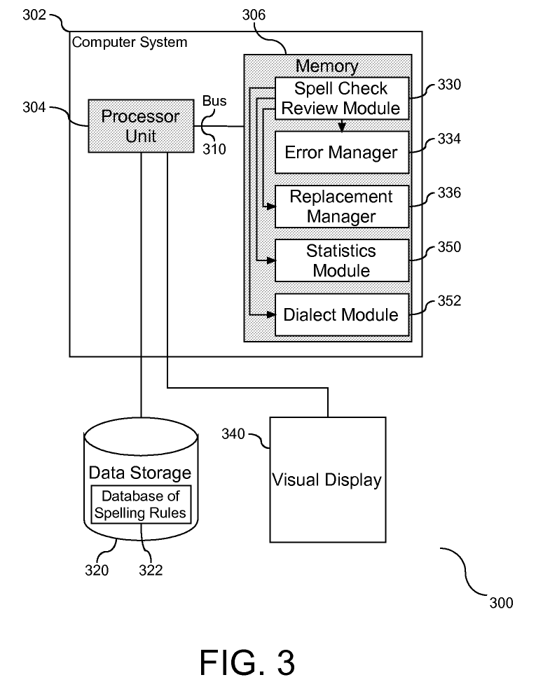

FIG. 3 is a block diagram (300) illustrating placement of a module for teaching correction of spelling errors. The illustration shows a computer system (302) with a processor unit (304) coupled to memory (306) by a bus structure (310). Although only one processor unit (304) is shown, in one embodiment, the computer system (302) may include more processor units in an expanded design. The computer system (302) includes data storage (320) and a visual display (340), both in communication with the processor unit (304). A spell check review module (330) is provided local to the system to review one or more documents for spelling errors. The review module (330) examines all of the words found in the document determined to have a spelling error. A database of spelling rules (322) are provided local to the data storage (320). The review module (330) is in communication with an error manager (334), which consults the spelling rules (322) to determine if at least one of the spelling rules applies to the words subject to the spelling error. A replacement manager (336) is provided in communication with the review module (330). The replacement manager (336) replaces each of the words subject to the spelling error with a properly spelled word. A spelling rule associated with the spelling error may be conveyed on the visual display (340). Accordingly, in addition to correcting a spelling error, an associated rule to correct the error is conveyed to the user.

Secondary modules may also be provided in the system (300) to enhance the education aspects. More specifically, a statistics module (350) may be employed in communication with the review module (330). The statistics module (350) maintains statistical data pertaining to spelling errors. More specifically, the statistics module (350) tracks the spelling errors together with the associated rules. In one embodiment, the statistics module is employed to determine the frequency at which errors are repeated. Statistical data may be conveyed to an instructor through a distributed network, or conveyed locally on the visual display (340).

Spell checkers are based upon a select language. Within many languages, there may be one or more dialects. In one embodiment, a dialect module (352) may be provided in communication with the review module (330) and the error manager (334). The dialect module (352) reflects the differences in spelling that may occur in different dialects by presenting a dialect reminder together with a word determined to have a spelling error. In one embodiment, differences in dialects may lend themselves to differences in spelling. Similarly, spell check modules may be provided to support different languages. In one embodiment, the review module (330) is employed to select a database with an appropriate dictionary language for the document.

As shown herein, the managers and modules each reside in memory (306) local to the computer system. In one embodiment, the managers and modules may reside as hardware tools external to local memory, or they may be implemented as a combination of hardware and software. Similarly, in one embodiment, the managers and modules may be combined into a single functional item that incorporates the functionality of the separate items. As shown herein, each of the managers and modules are local to the computer system (302). However, in one embodiment they may be collectively or individually distributed across the network and function as a unit to collect, classify, and assign collected data to the taxonomy. Accordingly, the managers and modules may be implemented as software tools, hardware tools, or a combination of software and hardware tools, to collection and organize data content.

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk read only (CD-ROM), compact disk read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

The software implementation can take the form of a computer program product accessible from a computer-useable or computer-readable medium providing program code for use by or in connection with a computer or any instruction execution system.

### Advantages Over the Prior Art

Spell checking rules are determined and conveyed to function in conjunction with a spell checker. The spell checking rules function to teach the spelling error, and not to merely allow the spell checker to communicate a correct spelling of a subject word or correct spelling of various words deemed similar in structure to the incorrectly spelled word. The rules in conjunction with ancillary exercises are employed to teach the person who made the error the logic for the correction, and to mitigate repeating the error on future uses of the word.

### Alternative Embodiments

It will be appreciated that, although specific embodiments of the invention have been described herein for purposes of illustration, various modifications may be made without departing from the spirit and scope of the invention. In particular, the scope of the invention is not limited to a word processor and teaching spelling with associated documents. In one embodiment, the teaching function may be applied to electronic mail programs, and other applications employed that support review of spelling errors. Similarly, in one embodiment, a user authentication module is invoked prior to initiating use of the spell checker. The authentication module identifies the user and ensures that any data maintained pertaining to spelling errors and correction is associated with the identified user. In one embodiment, a teaching module may be provided that provides related testing pertaining to the spelling error. The teaching module enhances the educational aspect of the rule location and evaluation. Accordingly, the scope of protection of this invention is limited only by the following claims and their equivalents.

We claim:

1. A method for teaching spelling, comprising:
reviewing a document in search of at least one improperly spelled word, including reviewing all of the words in the document;
examining all words found in the document determined to have a spelling error, including reviewing a database of spelling rules associated with the spelling error;
determining if at least one of the spelling rules apply to the words subject to the spelling error; and
displaying the at least one spelling rule to explain an underlying source of the spelling error.

2. The method of claim 1, further comprising replacing each of the words subject to the spelling error with a properly spelled word.

3. The method of claim 1, wherein the step of reviewing a database of spelling rules includes selecting a database with an appropriate dictionary language for the document.

4. The method of claim 1, wherein the step of displaying the at least one spelling rule to explain an underlying source of the spelling error, includes presenting a dialect reminder associated with the word determined to have a spelling error.

5. The method of claim 1, further comprising maintaining statistics for spelling error repetition.

6. The method of claim 1, further comprising activating an education module with at least one exercise pertaining to an identified spelling rule for teaching correction of the spelling error.

7. A computer system, comprising:
a processor in communication with memory;
a review module to review a document in search of at least one improperly spelled word, including a review of all of the words in the document;
the review module to examine all words found in the document determined to have a spelling error, including reviewing a database of spelling rules associated with the spelling error;
an error manager, in communication with the review module, to determine if at least one of the spelling rules apply to the words subject to the spelling error; and
a visual display, in communication with the error manager, to display the at least one spelling rule to explain an underlying source of the spelling error.

8. The system of claim 7, further comprising a replacement manager in communication with the review module, the replacement manager to replace each of the words subject to the spelling error with a properly spelled word.

9. The system of claim 7, wherein the review module selects a database with an appropriate dictionary language for the document.

10. The system of claim 7, further comprising a dialect module in communication with the error manager, the dialect module to present a dialect reminder associated with the word determined to have a spelling error.

11. The system of claim 7, further comprising a statistics module in communication with the error manager, the statistics module to maintain statistics for spelling error repetition.

12. The system of claim 7, further comprising an education module with at least one exercise pertaining to an identified spelling rule activated to teaching correction of the spelling error.

13. An article configured to review a document for spelling errors, the article comprising:
a computer readable carrier including computer program instructions configured to teach a correction of the spelling error, the instructions comprising:
instructions to review a document in search of at least one improperly spelled word, including reviewing all of the words in the document;
instructions to examine all words found in the document determined to have a spelling error, including reviewing a database of spelling rules associated with the spelling error;
instructions to determine if at least one of the spelling rules apply to the words subject to the spelling error; and
displaying the at least one spelling rule to explain an underlying source of the spelling error.

14. The article of claim 13, further comprising instructions to replace each of the words subject to the spelling error with a properly spelled word.

15. The article of claim 13, wherein the instructions to review a database of spelling rules includes selection of a database with an appropriate dictionary language for the document.

16. The article of claim 13, wherein the display of the at least one spelling rule to explain an underlying source of the spelling error, includes presenting a dialect reminder associated with the word determined to have a spelling error.

17. The article of claim 13, further comprising instructions to maintain statistics for spelling error repetition.

18. The article of claim 13, further comprising instructions to activate an education module with at least one exercise pertaining to an identified spelling rule for teaching correction of the spelling error.
